(19) United States
(12) Patent Application Publication
(10) Pub. No.: US 2010/0138916 A1
(43) Pub. Date: Jun. 3, 2010

(54) Apparatus and Method for Secure Administrator Access to Networked Machines

(76) Inventors: William F. Price, III, Los Altos, CA (US); Rolf Wagner, JR., Foster City, CA (US); Earle Morven Lowe, Roseville, CA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/326,743

(22) Filed: Dec. 2, 2008

(51) Int. Cl. H04L 9/32; G06F 21/00

(52) U.S. Cl. 726/20

(57) ABSTRACT

A secure access method includes generating administrator access security information including a public and private key pair. The administrator access security information is associated with a set of client users assigned to a specified group. Each client user has personal security credentials for accessing a client computer. The administrator access security information is copied to a set of security tokens. The security tokens are distributed. A client computer associated with a client user of the set of client users is accessed by utilizing one of the security tokens instead of personal security credentials for the client computer.

### FIELD OF THE INVENTION

This invention relates generally to security in computer networks. More particularly, this invention relates to techniques to facilitate secure administrator access to networked machines.

### BACKGROUND OF THE INVENTION

Entities that operate computer networks typically have a number of client users operating client machines and a number of administrators operating server machines and assisting with work on client machines. Typically, each client user has personal security credentials including a user name and password. Similarly, each administrator typically has a administrator identification data including an administrator name and administrator password. When an administrator needs to work on a client user's machine, the user needs to provide the administrator with his or her personal security credentials. This information may be passed in an email or on a piece of paper, which leads to security vulnerabilities. Additional security vulnerabilities arise when an administrator leaves an organization. In such instances, it may be cumbersome to disable the administrator's access to the network and/or to thwart the administrator from using another's personal security credentials.

In view of the foregoing, it would be desirable to afford an administrator access to a client user machine without the user having to supply his or her personal security credentials. In addition, it would be desirable to provide techniques to easily disable an administrator's access to network resources.

### SUMMARY OF THE INVENTION

The invention includes a secure access method of generating administrator access security information including a public and private key pair. The administrator access security information is associated with a set of client users assigned to a specified group. Each client user has personal security credentials for accessing a client computer. The administrator access security information is copied to a set of security tokens. The security tokens are distributed. A client computer associated with a client user of the set of client users is accessed by utilizing one of the security tokens instead of personal security credentials for the client computer.

The invention also includes a computer readable storage medium with executable instructions to generate administrator access security information including a public and private key pair. The administrator access security information is associated with a set of client users assigned to a specified group. Each client user has personal security credentials for accessing a client computer. The administrator access security information is copied to a security token such that the security token can access a client computer associated with a client user of the set of client users without the personal security credentials for the client computer.

The invention also includes a computer readable storage medium associated with a client computer. The computer readable storage medium includes executable instructions to read a security token with a public and private key pair to secure administrator access security information associated with a set of client users assigned to a specified group. Each client user has personal security credentials for accessing a client computer. The administrator access security information is compared with stored administrator access security information to identify a match. Access to the client machine is granted in the event of a match.

### BRIEF DESCRIPTION OF THE FIGURES

The invention is more fully appreciated in connection with the following detailed description taken in conjunction with the accompanying drawings, in which:

FIG. 1 illustrates processing operations associated with an embodiment of the invention.

FIG. 2 illustrates a computer system configured in accordance with an embodiment of the invention.

Like reference numerals refer to corresponding parts throughout the several views of the drawings.

### DETAILED DESCRIPTION OF THE INVENTION

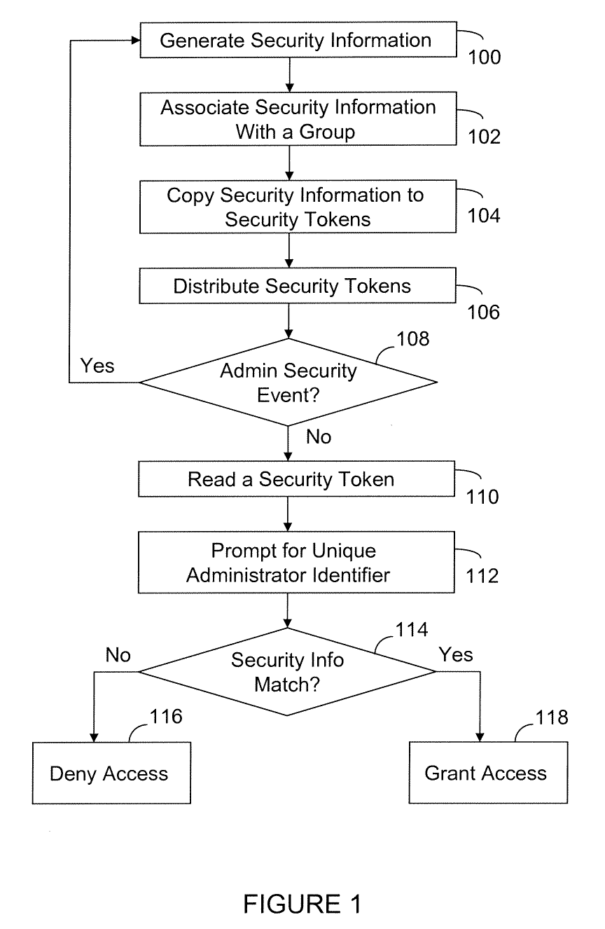

FIG. 1 illustrates processing operations associated with an embodiment of the invention. Security information is generated 100. For example, a server computer may generate security information in the form of a digital public and private key pair. The security information is also referred to herein as administrator access security information.

The security information is then associated with a group 102. The group may be all users associated with a network. Alternately, the group may be a subset of users associated with a network used by an enterprise. For example, the group may be the engineering department of an enterprise, the legal department of an enterprise or the finance department of an enterprise. Regardless of the group composition, users within a group securely receive the security information. For example, a server may securely distribute the information to a set of client machines utilized by users within a group. The security information is stored on the client machines, but is typically not accessible to the client user.

The security information is then copied to a security token 104. Preferably, a unique administrator identifier, such as an administrator password, is associated with each security token. That is, each security token receives the administrator access security information and a unique administrator identifier. Copying the information to the token also contemplates generating a key pair on a token in a non-removable fashion for highest security. In this case, the key pair is formed or initiated on the token.

As used herein, the term security token refers to a physical device that an authorized user of a computer is given to aid in authentication. The security token is typically a compact device with an embedded integrated circuit to store and/or process information. It may contain non-volatile memory to store a digital key or other security information. A security token has tamper resistant properties, such as a secure crypto-processor and/or secure file system. A security token may be configured as a smart card the size of a credit card, e.g., the ID-1 of ISO/IEC 7810 standard specifies a 85.60×53.98 mm configuration. A security token may also be configured as a device with a Universal Serial Bus (USB) port. A security token may also be referred to as an access token, chip card or Integrated Circuit Card (ICC). Commercially available security tokens that may be used in accordance with the invention include Aladdin eToken 64K, Aladdin eToken PRO USB Key 32K, and Athena ASEKey Crypto USB Token for Microsoft ILM.

The security tokens are then distributed 106. For example, the security tokens are distributed to a set of system administrators. Periodically, it is determined whether there is an administrator security event 108. An administrator security event 108 is an event that potentially compromises system security, such as losing a security token or a system administrator leaving an organization. If an administrator security event occurs (108—YES), operations 100-106 are repeated. If such an event does not occur, then the security tokens may be used to access a client machine. For example, a system administrator may apply a security token to a client machine. The security token is read 110. The administrator is preferably prompted for a unique administrator identifier (e.g., an administrator password) 112. The use of a unique administrator identifier provides another level of security in the event that a security token is stolen or is otherwise utilized by an unauthorized party.

If the security information does not match (114—NO), then access is denied 116. If the security information matches (114—YES), then access is granted 118. Since the security token includes a key pair, the encrypted key on the client computer may be decrypted by the token and then returned to the client computer. Observe then that an administrator gains access to a client computer without every having access to the personal security credentials of the client user.

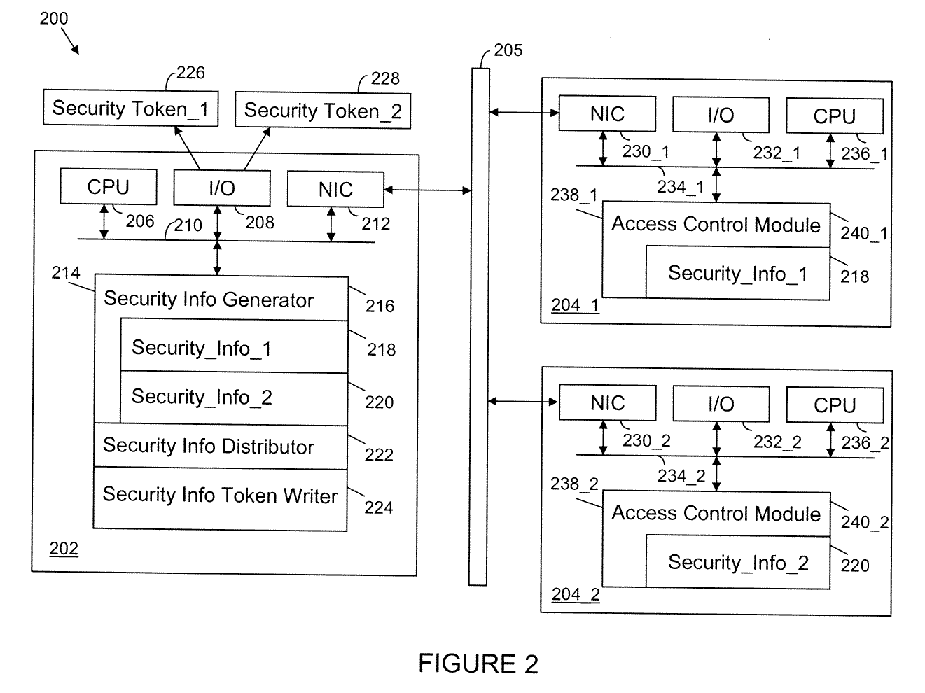

FIG. 2 illustrates a system 200 to implement operations of the invention. The system 200 includes a server computer 202 and a set of client computers, represented here as two computer 204_1 and 204_2. The computers 202 and 204 are connected via a transmission channel 205, which may be any wired or wireless transmission channel.

The server 202 includes standard components, such as a central processing unit 206 and input/output devices 208 connected via a bus 210. The input/output devices 208 include standard components, such as a keyboard, mouse, display, printer and the like. The input/output devices 208 also include a hardware based security token writer, which writes security information to a security token in response to instructions from a software based security information token writer, which is discussed below.

A network interface circuit 212 is also connected to the bus 210. The network interface circuit 212 provides connectivity to the other computers 204 in the system 200. A memory 214 is also connected to the bus 210. The memory 214 includes executable instructions to implement operations of the invention. The memory 214 stores a security information generator 216, which includes executable instructions to generate administrator access security information, such as digital public and private key pairs. In addition, the security information generator 216 includes executable instructions to associate the security information with a specified group of individuals. For example, a first set of security information, called security_info_1 218, is associated with a first group of individuals in an enterprise, say the engineering department. A second set of security information, called security_info_2 220, is associated with a second group of individuals in an enterprise, say the legal department. Thus, different groups of individuals are associated with different administrator access security information.

The memory 214 also stores a security information distributor 222. The security information distributor includes executable instructions to download administrator access security information to client computers associated with individuals within a group. Thus, for example, the security information distributor 222 may download security_info_1 218 to client computer 204_1 and security_info_2 220 to computer 204_2. In this example, client computer 204_1 is associated with a user affiliated with a first group, while client computer 204_2 is associated with a user affiliated with a second group. As previously indicated, the security information is stored on a client machine, but should not be accessible to a client user.

The memory 214 also includes a security information token writer 224. The security information token writer 224 includes executable instructions to access security information and generate appropriate instructions that are processed by a peripheral device that is used to write the security information to a security token. For example, the security information token writer 224 includes executable instructions to fetch security_info_1 218 and write that information to a peripheral device associated with the input/output devices 208 to form a first security token 226. A second security token 228 is formed in the same manner. The security tokens are then distributed to network administrators.

Each client computer 204 also includes standard components, such as a network interface circuit 230, which coordinates network connectivity. The network interface circuit 230 is connected to input/output devices 232 and central processing unit 236 via bus 234. The input/output devices 232 include standard components, such as a keyboard, mouse, display and security token reader.

A memory 238 is also connected to the bus 234. The memory 238 includes an access control module 240, which includes executable instructions to control access to a client machine 204. The access control module 240 may include executable instructions for whole disk encryption of data within a client machine 204. The access control module 240 includes executable instructions to control access by network administrators. In particular, a network administrator requires an appropriate security token to initiate access to a client machine. For example, security token 226 with security_info_1 218 is required for access to machine 204_1, while security token 228 with security_info_2 220 is required for access to machine 204_2. As previously indicated, security_info_1 218 is downloaded to client 204_1 from the security information distributor 222 of server 202. Similarly, security_info_2 220 is downloaded to client 204_2 from the same security information distributor 222.

A network administrator with security token 226 can access computer 204_1 by having a token reader associated with input/output devices 232 read the security token 226, typically at boot-up. The administrator is then preferably prompted, via the access control module 240, for an administrator password. If the access control module 240 identifies a match, then access may be granted to the machine.

Observe then that a network administrator has gained access to a client machine without the owner of the client machine disclosing his or her personal security credentials to the network administrator. Thus, potential security breaches associated with third-parties identifying this information when it is exchanged is avoided. Similarly, the user need not be concerned that the network administrator will subsequently use his or her user name and password in an authorized manner since the network administrator never learns that information. If a network administrator leaves an organization, new administrator access security information is generated, as previously discussed. If a network administrator loses a security token, the requirement for a unique administrator identifier associated the security token insures security. If necessary, new security information may be generated when a security token is lost.

As previously discussed, the size of a group may range from an entire organization to a department of an organization. The size of the group is tailored for trade offs between administrator convenience and security. Convenience is diminished as the number of groups increases, but security is enhanced.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A secure access method, comprising:
generating administrator access security information including a public and private key pair;
associating the administrator access security information with a set of client users assigned to a specified group, each client user having personal security credentials for accessing a client computer;
copying the administrator access security information to a set of security tokens;
distributing the security tokens; and
accessing a client computer associated with a client user of the set of client users by utilizing one of the security tokens instead of personal security credentials for the client computer.

2. The secure access method of claim 1 further comprising accessing a client computer using a unique administrator identifier associated with the security token distributed to each administrator.

3. The secure access method of claim 1 further comprising identifying an administrator security event selected from a lost security token and a departed administrator.

4. The secure access method of claim 3 further comprising repeating said generating, associating, copying and distributing in response to identifying.

5. The secure access method of claim 1 wherein associating the administrator access security information includes downloading the administrator access security information from a server to client computers used by the client users assigned to the specified group.

6. The secure access method of claim 2 further comprising:
supplying a security token at a client computer; and
entering into the client computer a unique administrator identifier.

7. The secure access method of claim 1 further comprising performing administrator tasks at the client computer.

8. A computer readable storage medium, comprising executable instructions to:
generate administrator access security information including a public and private key pair;
associate the administrator access security information with a set of client users assigned to a specified group, each client user having personal security credentials for accessing a client computer; and
copy the administrator access security information to a security token such that the security token can access a client computer associated with a client user of the set of client users without the personal security credentials for the client computer.

9. The computer readable storage medium of claim 8 further comprising executable instructions to assign an administrator identifier to the security token.

10. The computer readable storage medium of claim 9 wherein the administrator identifier includes an administrator password.

11. The computer readable storage medium of claim 10 wherein the executable instructions to associate include executable instructions to download the administrator access security information from a server machine to client computers used by the set of client users assigned to the specified group.

12. A computer readable storage medium associated with a client computer, comprising executable instructions to:
read a security token with a public and private key pair to secure administrator access security information associated with a set of client users assigned to a specified group, each client user having personal security credentials for accessing a client computer;
compare the administrator access security information with stored administrator access security information to identify a match; and
grant access to the client machine in the event of a match.

13. The computer readable storage medium of claim 12 further comprising executable instructions prompt a user for an administrator password.
